(19) United States
(12) Patent Application Publication
(10) Pub. No.: US 2007/0281599 A1
(43) Pub. Date: Dec. 6, 2007

(54) Air passage switching device

(75) Inventor: Kenji Mori, Nishio-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/810,120

(22) Filed: Jun. 4, 2007

(30) Foreign Application Priority Data
Jun. 5, 2006 (JP) 2006-155733

(51) Int. Cl. B60H 3/00; B60H 1/00; B60S 1/54

(52) U.S. Cl. 454/121; 454/69; 165/43

(57) ABSTRACT

An air passage switching device includes a case for defining an air passage, a butterfly door having a door body and a rotation shaft, a bearing part provided in the case for rotatably holding the rotation shaft, and a seal structure. The seal structure has a first seal part disposed at an outer peripheral portion of the rotation shaft to be integrally rotated with the rotation shaft, and a second seal part disposed in the case. The first seal part and the second seal part have scroll shapes centering on an axial center of the rotation shaft. The first seal part is in contact with the second seal part when the door body closes the air passage.

### CROSS REFERENCE TO RELATED APPLICATION

This application is based on Japanese Patent Applications No. 2006-155733 filed on Jun. 5, 2006, the content of which is incorporated herein by reference in its entirety.

### BACKGROUND OF THE INVENTION

1. Field of the Invention

The present invention relates to an air passage switching device. The air passage switching device can be suitably used for an air outlet mode switching device for a vehicle air conditioner, for example.

2. Description of the Related Art

Conventionally, an air passage switching device has an air conditioning case for forming an air passage, and a butterfly door disposed in the air conditioning case. The butterfly door has a plate-shaped door body for opening and closing the air passage, and a rotation shaft integrally formed with the door body at a center portion of the door body. The rotation shaft is rotatably held by a bearing part in the case. The rotation shaft is rotated for rotating the door body, so as to switch the air passage.

When the bearing part rotatably holds the rotation shaft, a gap may be formed between the rotation shaft and the bearing part. In a case where the gap is formed, when the butterfly door closes the air passage, air may be leaked from an upstream air side with respect to the butterfly door to an outside through the gap.

Therefore, U.S. Pat. No. 6,047,951 (corresponding to JP-A-11-180129) discloses an air passage switching device having a first cylindrical portion and a second cylindrical portion. The first cylindrical portion is formed concentrically with the rotation shaft at an outer peripheral side of an axial end. The second cylindrical portion is formed in the case. The second cylindrical portion is engaged with an inner peripheral side of the first cylindrical portion, so that a gap between the inner peripheral surface of the first cylindrical portion and an outer peripheral surface of the second cylindrical portion becomes small, and an overlapped amount, in which the first cylindrical portion and the second cylindrical portion overlap with each other, is sufficient. Thus, the air passage switching device restricts an air leak to the outside through the gap.

However, a seal structure around the rotation shaft disclosed in U.S. Pat. No. 6,047,951 is formed so that only the gap between the first cylindrical portion and the second cylindrical portion becomes small. Therefore, when the butterfly door closes the air passage, the air may be leaked from an upstream air side of the butterfly door to a downstream air side of the butterfly door through the small gap.

### SUMMARY OF THE INVENTION

In view of the foregoing problems, it is an object of the present invention to provide an air passage switching device which prevents an air leak from an upstream air side of a butterfly door to a downstream air side of the butterfly door when an air passage is closed by the butterfly door.

An air passage switching device according to a first aspect of the invention includes a case for defining an air passage through which air flows, a butterfly door having a door body and a rotation shaft, a bearing part provided in the case for rotatably holding the rotation shaft, and a seal structure for preventing an air leak from a gap between the rotation shaft and the bearing part. The rotation shaft is disposed at a center portion of the door body for integrally rotating with the door body. The seal structure has a first seal part disposed at an outer peripheral portion of the rotation shaft to be integrally rotated with the rotation shaft, and a second seal part disposed in the case. The first seal part and the second seal part have scroll shapes centering on an axial center of the rotation shaft. The first seal part is in contact with the second seal part, when the door body closes the air passage.

Because the first seal part disposed at the outer peripheral portion of the rotation shaft is in contact with the second seal part disposed in the case, the seal structure seals the gap between an end portion of the rotation shaft and the case, and prevents an air leak from an upstream air side to a downstream air side of the door body, when the door body closes the air passage.

Further, the first seal part and the second seal part have the scroll shapes centering on the axial center. Therefore, when the first seal part rotates with the rotation shaft, a distance between the first seal part and the axial center becomes different from a distance between the second seal part and the axial center in a certain radial direction.

Thus, when the door body rotates in the direction to open the air passage, the first seal part rotates in a direction to separate from the second seal part. Therefore, a friction between the first seal part and the second seal part is reduced. As a result, the rotation shaft is rotatable without increasing an operation force. Further, a noise due to the friction between the first seal part and the second seal part is prevented.

An air passage switching device according to a second aspect of the invention includes a case for defining an air passage through which air flows, a butterfly door having a door body and a rotation shaft, a bearing part provided in the case for rotatably holding the rotation shaft, and a seal structure for preventing an air leak from a gap between the rotation shaft and the bearing part. The rotation shaft is disposed at a center portion of the door body for integrally rotating with the door body. The seal structure has a first seal part disposed at an outer peripheral portion of the rotation shaft to be integrally rotated with the rotation shaft, and a second seal part disposed in the case. The first seal part is in contact with the second seal part throughout a circumference of the rotation shaft in a predetermined range in one of a range which is provided on an upstream air side of the door body, and a range which is provided on a downstream air side of the door body, when the door body closes the air passage.

When an outer end part of the door body is in contact with the case, a gap between the door body and the case is sealed. In the butterfly door, in which the rotation shaft is disposed at the center portion of door body, door surfaces of the door body located on two sides of the rotation shaft. When the seal structure is provided to connect two door surfaces arranged on an upstream air side, or two door surfaces arranged on a downstream air side, the seal structure prevents an air leak from the upstream air side to the downstream air side of the door body.

In the air passage switching device according to the second aspect of the invention, the first seal part disposed in one of the above-described ranges. Therefore, the air passage switching device prevents an air leak from the upstream air side to the downstream air side of the door body, when the door body closes the air passage, without arranging the seal structure throughout a range of the circumference of the rotation shaft.

Further, the first seal part is formed to contact the second seal part for sealing. Therefore, the seal structure prevents an air leak from the upstream air side to the downstream air side without little air leak.

An air passage switching device according to a third aspect of the invention includes a case for defining an air passage through which air flows, a butterfly door having a door body and a rotation shaft, a bearing part provided in the case for rotatably holding the rotation shaft, and a seal structure for preventing an air leak from a gap between the rotation shaft and the bearing part. The rotation shaft is disposed at a center portion of the door body for integrally rotating with the door body. The seal structure has a first seal part disposed at an outer peripheral portion of the rotation shaft to be integrally rotated with the rotation shaft, and a second seal part disposed in the case. The first seal part is in contact with the second seal part for preventing an air leak from an upstream air side to a downstream air side of the door body, when the door body closes the air passage. The first seal part moves in a direction in which the first seal part separates from the second seal part, when the door body rotates in a direction to open the air passage.

Because the first seal part is in contact with the second seal part when the door body closes the air passage, the seal structure prevents an air leak from the upstream air side to the downstream air side of the door body without little air leak.

Further, the first seal part moves in a direction in which the first seal part separates from the second seal part, when the door body rotates in a direction to open the air passage. Therefore, a friction between the first seal part and the second seal part is reduced. As a result, the rotation shaft is rotatable without increasing the operation force. Further, a noise due to the friction between the first seal part and the second seal part is prevented.

### BRIEF DESCRIPTION OF THE DRAWINGS

Additional objects and advantages of the present invention will be more readily apparent from the following detailed description of preferred embodiments when taken together with the accompanying drawings. In the drawings:

FIG. 1 is a cross-sectional view showing an air conditioning unit of a vehicle air conditioner according to a first embodiment of the invention;

FIG. 2A is a plan view showing a defroster door in the air conditioning unit, and the FIG. 2B is a right side view of the defroster door in FIG. 2A;

FIG. 3A is a cross-sectional view of a seal structure according to the first embodiment, and FIG. 3B is a side view of the seal structure, when a defroster air passage is closed;

FIG. 4A is a cross-sectional view of the seal structure according to the first embodiment, and FIG. 4B is a side view of the seal structure, when the defroster air passage is partially opened;

FIG. 5A is a cross-sectional view of the seal structure according to the first embodiment, and FIG. 5B is a side view of the seal structure, when the defroster air passage is fully opened;

FIG. 6A is a cross-sectional view of a seal structure according to a second embodiment of the invention, and FIG. 6B is a side view of the seal structure, when the defroster air passage is closed;

FIG. 7A is a cross-sectional view of the seal structure according to the second embodiment, and FIG. 7B is a side view of the seal structure, when the defroster air passage is fully opened; and

FIG. 8 is a cross-sectional view of an air passage switching device according to other embodiment of the invention.

### DETAILED DESCRIPTION OF THE PREFERRED EMBODIMENTS

### First Embodiment

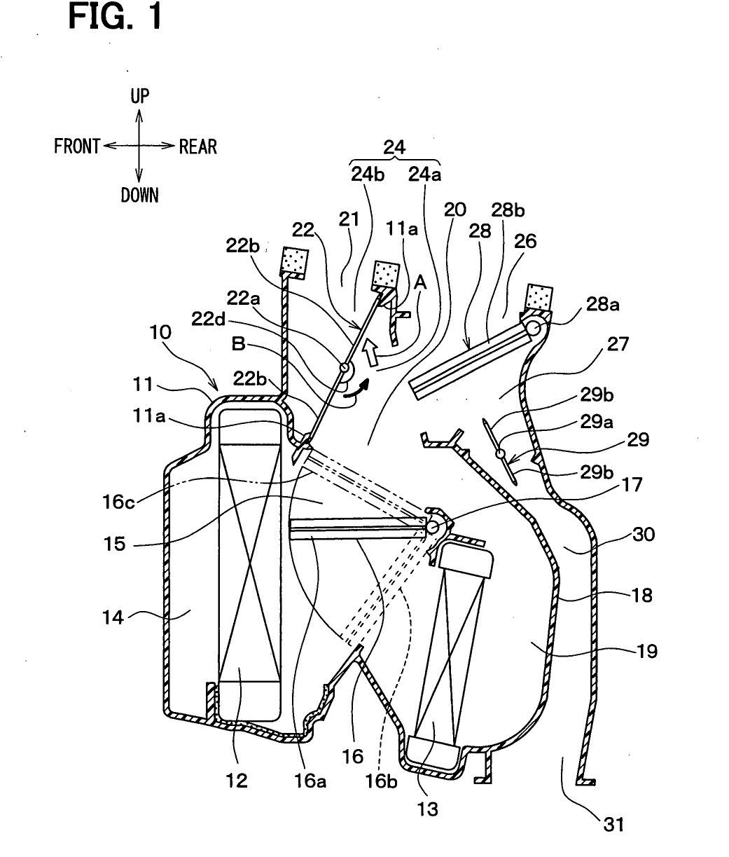

A first embodiment will be now described with reference to FIGS. 1-5B. An air passage switching device according to the first embodiment of the invention can be suitably used for an air outlet mode switching device for a vehicle air conditioner. The vehicle air conditioner includes an interior unit part located in a passenger compartment of the vehicle. The interior unit part has an air conditioning unit 10 and a blower unit (not shown) for blowing air to the air conditioning unit 10. For example, the air conditioning unit 10 is disposed in the passenger compartment at an approximately center portion of an instrument panel (dashboard) in a vehicle width direction (i.e., right-left direction of a vehicle). The air conditioning unit 10 is disposed in the vehicle in the arrangement direction shown by arrows (i.e., up, down, front, and rear) in FIG. 1. The instrument panel (not shown) is disposed at a front part of the passenger compartment of the vehicle. The blower unit is disposed in the passenger compartment at a front passenger's side shifted from the air conditioning unit 10 in the vehicle width direction, for example.

The blower unit has an inside/outside air switching box for selectively introducing an outside air of the passenger compartment and an inside air of the passenger compartment, and a blower for sucking air though the inside/outside air switching box and blowing the air. The blower has a centrifugal multiblade fan (sirocco fan) and an electric motor for driving the centrifugal multiblade fan. The electric motor is driven by a control voltage of an air-conditioning control device (not shown).

The air conditioning unit 10 has an air conditioning case 11 which defines an air passage for leading air toward the passenger compartment. The case 11 is made of a resin (e.g., polypropylene, nylon, and ABS) which has a certain level of elasticity, and a good strength. The case 11 has a separating surface formed in an up-down direction, and disposed at an approximately center portion in the vehicle width direction, for separating the case 11 into right and left parts.

The case 11 houses an evaporator 12 for forming a heat exchanger for cooling, a heater core 13 for forming a heat exchanger for heating, an air mixing door 16, a defroster door 22, a face door 28, and foot door 29, etc. These components (12, 13, 16, 22, 28, and 29) are attached to the case 11 by fastenings such as a metal spring clip and a screw.

The case 11 has an air inlet space 14 which is formed on the most front side of the vehicle. The air blown by the blower flows into the air inlet space 14. The evaporator 12 is disposed in an approximately up-down direction (approximately vertically) on a downstream air side (i.e., rear side of the vehicle) with respect to the air inlet space 14. The evaporator 12 cools air by absorbing heat from air when a low-pressure refrigerant of a refrigeration cycle (not shown) evaporates.

The heater core 13 is disposed approximately vertically at a predetermined distance from the evaporator 12 on a downstream air side. The heater core 13 is introduced with a high-temperature engine cooling water (hot water), and heat exchanges between the hot water and cool air having passed through the evaporator 12, so as to heat air from the evaporator 12.

When the evaporator 12 and the heater core 13 are arranged approximately vertically, their surfaces, which form heat-exchanging cores, extend to the up-down direction. Thus, the air flowing into the air inlet space 14 of the case 11 is cooled while passing through the evaporator 12, and is heated while passing through the heater core 13.

A cool air bypass passage 15 is formed in a portion on a rear side of the evaporator 12. The cool air from the evaporator 12 bypasses the heating core 13 through the cool air bypass passage 15. Between the evaporator 12 and the heater core 13, the air-mixing door 16 is disposed for controlling a ratio of an air volume of the warm air, which is heated by the heater core 13, and an air volume of cool air, which passes through the cool air bypass passage 15 and bypasses the heater core 13.

The air-mixing door 16 controls a temperature of air to be blown to the passenger compartment by controlling the ratio of the air volumes between the warm air and the cool air. The air-mixing door 16 is a rotating door which has a rotation shaft 17 extends to the right-left direction of the vehicle, and a plate-shaped door body 16a which is connected to and rotates with the rotation shaft 17. In the first embodiment, the air-mixing door 16 is a cantilevered door in which the rotation shaft 17 is connected to a side of the door body 16a.

A dotted-line position 16b shows a maximum cooling position of the air-mixing door 16 in which the air-mixing door 16 fully closes an inlet of a passage to the heater core 13 and fully opens the cool air bypass passage 15. In contrast, a dashed-two dotted line position 16c shows a maximum heating position of the air-mixing door 16 in which the air-mixing door 16 fully closes the cool air bypass passage 15 and fully opens the inlet of the passage to the heater core 13.

The rotation shaft 17 is disposed at a front portion of an upper end of the heater core 13. The rotation shaft 17 is rotatably held by bearing holes (not shown) provided in right and left wall surfaces of the case 11. Further, the rotation shaft 17 protrudes to an outside of the case 11, and is connected to a temperature-control operating system (not shown) through a link system (not shown).

The temperature-control operating system includes an actuator having a servomotor, and controls a rotational position of the air-mixing door 16. The actuator is driven by a control signal of the air-conditioning control device (not shown). The temperature-control operating system may include a manual operation system. A wall 18 is integrally formed with the case 11 on a downstream air side with respect to the heater core 13. The wall 18 extends to the up-down direction, and disposed at a predetermined distance from the heater core 13. The wall 18 is located downstream of the heater core 13 to form a hot air passage 19 in which the hot air flows upwardly from just behind the heater core 13.

An air-mixing space 20 is formed in a space which is provided on an upper side of the hot air passage 19, at an upper side of the heater core 13, and on a rear side of the cool air bypass passage 15. In the air-mixing space 20, the hot air passing through the heater core 13 and the cool air passing through the cool air bypass passage 15 are mixed for controlling a temperature of air flowing from the air-mixing space 20 to the passenger compartment. Thus, the temperature-control operating system controls the rotational position of the air-mixing door 16, for controlling the temperature of the conditioned air so as to be a predetermined temperature.

A defroster opening 21 is provided in an upper portion of the case 11 and an intermediate portion between the evaporator 12 and the heater core 13 in the front-rear direction. The defroster opening 21 is an opening for blowing the conditioned air from the air-mixing space 20 to an inner surface of a windshield.

Specifically, the defroster opening 21 is connected to a defroster outlet (not shown) provided in the passenger compartment, through a defroster duct (not shown). The conditioned air is blown from the defroster outlet to the inner surface of the windshield. Between the air-mixing space 20 and the defroster outlet, a defroster air passage 24, in which the conditioned air flows, is formed.

A face opening 26 is provided in an upper portion of the case 11 and on a rear side of the defroster opening 21. The face opening 26 is connected to a face outlet (not shown) provided on an upper side of the instrument panel, through a face duct. The conditioned air is blown from the face outlet to an upper body of a passenger in the passenger compartment.

At a lower portion of the face opening 26, a foot opening 27 is provided for flowing the conditioned air to a foot are of the passenger. Specifically, the face opening 27 is connected to foot outlets 31 provided at right and left lower ends on a rear side of the case 11. The air is discharged from the right and left foot outlets 31 to the under foot of the passenger. Between the air-mixing space 20 and the foot outlets 31, the foot air passage 30, in which the conditioned air flows, is formed.

The defroster door 22, the face door 28, and the foot door 29 are respectively disposed in the air passages from the air-mixing space 20 to the defroster opening 21, the face opening 26, and the foot opening 27. The air passages are switched by outlet mode doors (i.e., the defroster door 22, the face door 28, and the foot door 29).

In the first embodiment, the defroster door 22 has a rotation shaft 22a extending to the right-left direction of the vehicle, and plate-shaped door body 22b which is connected to the rotation shaft 22a to rotate integrally. The defroster door 22 is a butterfly door in which the rotation shaft 22a is disposed at a center portion of the door body 22b.

The face door 28 is a cantilever door in which the rotation shaft 28a is disposed at an end of a plate-shaped door body 28b, similarly to the air-mixing door 16. The foot door 29 is a butterfly door in which its rotation shaft 29a is disposed at a center portion of a plate-shaped door body 29b, similarly to the defroster door 22.

The outlet mode doors 22, 28 and 29 are simultaneously operated by a common outlet-mode door operation system (not shown). Specifically, the rotation shafts 22a, 28a and 29a of the outlet mode doors 22, 28 and 29 are rotationally held by bearing holes in the right and left walls of the case 11, and one ends of the rotation shafts 22a, 28a and 29a protrude to the outside of the case 11.

The protruded ends of the rotation shafts 22a, 28a and 29a are connected to the outlet-mode door operation system through a link system. The outlet-mode door operation system includes an actuator having a servomotor, for opening and closing the outlet mode doors 22, 28 and 29. The actuator is driven by a control signal of the air-conditioning control device.

When the outlet-mode door operation system operates the outlet mode doors 22, 28 and 29, an air outlet mode is switched to a face mode, a bi-level mode, a foot/defroster mode, or a defroster mode. The outlet-mode door operation system may include a manual operation system for manually switching an air outlet mode.

In FIG. 1, the air conditioning unit 10 is set to a bi-level mode in which the defroster door 22 closes the defroster air passage 24, the face door 28 opens the face air passage, and the foot door 29 opens the foot air passage 30. In the first embodiment, the air passage switching device according to the invention is used for a switching system of the defroster air passage 24, for example.

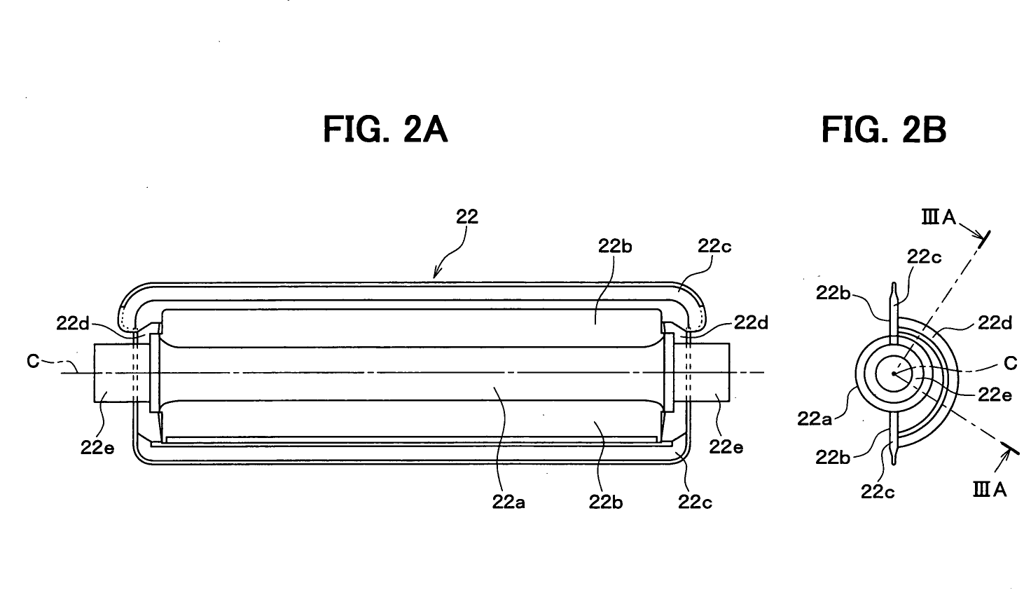

Next, the defroster door 22 will be described with reference to FIGS. 2A and 2B. As described above, the defroster door 22 is the butterfly door, in which the rotation shaft 22a is disposed at the center portion of the plate-shaped door 22b.

The defroster door 22 may have two door bodies 22b. The rotation shaft 22a are disposed between the two door bodies 22b which are arranged to be parallel, so that the door bodies 22b integrally rotates with the rotation shaft 22a. As shown in FIG. 2A, the door bodies 22b have flat and approximately rectangular shapes.

The rotation shaft 22a and the door bodies 22b are integrally formed with a material having a high rigidity and an inelasticity, such as resin. As a resin material for forming the rotation shaft 22a and the door bodies 22b, polypropylene, nylon, and ABS may be used. A filler such as glass fiber may be mixed into a resin material for enhancing the strength of the rotation shaft 22a and the door bodies 22b. Further, the rotation shaft 22a and the door bodies 22b may be formed with the same resin material as that of the case 11.

Seal members 22c are attached to outer peripheral portions of the door bodies 22b. The seal members 22c are made of an elastic material such as rubber, silicon rubber, and thermoplastic elastomer (TPE). The seal members 22c have thin plate shapes extending from the outer peripheral portions of the door bodies 22b to an outside.

As shown in FIG. 1, the case 11 has ribs 11a. The ribs 11a include a first rib 11a on an upper side of the defroster air passage 24 and a second rib 11a on a lower side of the defroster air passage 24. The ribs 11a protrude from the inner wall of the case 11. When the door bodies 22b close the defroster air passage 24, the ribs 11 become seal surfaces for contacting the seal members 22c. The ribs 22a are disposed to extend along approximately rectangular shapes of outer peripheral portions of the defroster door 22.

When the door bodies 22b close the defroster air passage 24, an upstream side surface of a first seal member 22c of a first door body 22b arranged on an upper side of the rotation shaft 22a contacts the fist rib 11a to be sealed therebetween. In addition, downstream side surface of the second seal member 22c of a second door body 22b arranged on a lower side of the rotation shaft 22a contacts the second rib 11a to be sealed therebetween. Thus, the seal members 22c tightly seal a gap between the door bodies 22b and the case 11 when the door bodies 22b close the defroster air passage 24.

When the door bodies 22b open the defroster air passage 24, the door bodies 22b rotate in a direction shown by the arrow B (anticlockwise in FIG. 1). The seal members 22c and the ribs 11a construct a door seal structure for sealing the gap, in the first embodiment.

As shown in FIG. 2A, first protruding parts (door side protruding parts) 22d are disposed at two axial ends of the rotation shaft 22a, to protrude to the outer peripheral side of the rotation shaft 22a. The first protruding parts 22d are made of the same elastic material as those of the seal members 22c, and are integrally formed with the seal members 22c.

When the door bodies 22b close the defroster air passage 24, the defroster air passage 24 is divided into an upstream space 24a on an upstream air side and a downstream space 24b on a downstream air side, and the first protruding parts 22d are arranged on a side of the upstream space 24a.

As shown in FIG. 2B, each of the first protruding parts 22d has an inner peripheral surface and an outer peripheral surface. Each of the first protruding parts 22d is formed so that a distance between the inner peripheral surface and an axial center C of the rotation shaft 22a gradually decreases toward the direction shown by the arrow B in FIG. 1.

The door bodies 22b and the seal members 22c and the first protruding parts 22d are easily formed integrally by insert-molding. For example, rubber material for forming the seal members 22c and the first protruding parts 22d are set in predetermined positions in a mold used for forming the door bodies 22b. Then, the resin material is injected in the mold for integrally forming and fixing the door bodies 22b and the seal members 22c and the first protruding parts 22d.

Shaft holding parts 22e are formed at two axial ends of the rotation shaft 22a. The shaft holding parts 22e protrude outside more than the first protruding parts 22d, in an axial direction of the rotation shaft 22a. The shaft holding parts 22e are inserted in bearing holes 11b formed in the case 11 on an approximately same axis as the axial center C, so that the defroster door 22 is rotatably held by the case 11.

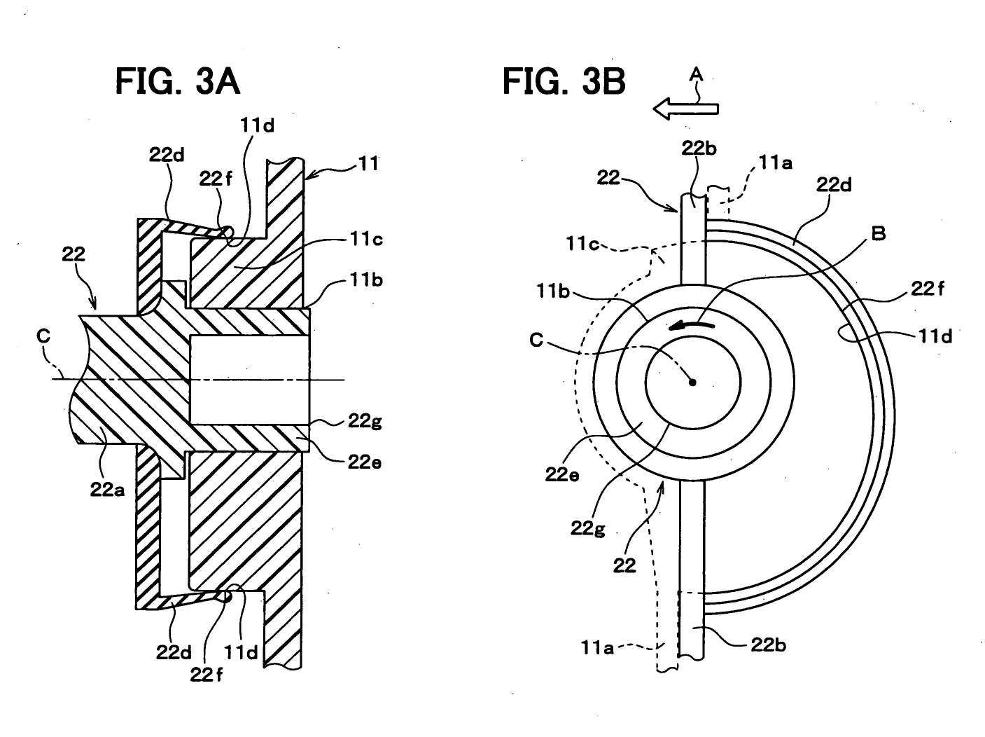

Next, the first protruding parts 22d, the shaft holding parts 22e, and portions surrounding the bearing holes 11b in the case 11 will be described with reference to FIGS. 3A and 3B. FIG. 3A is a cross-sectional view showing the first protruding part 22d and the portion surrounding the bearing hole 11b in the case 11 when the defroster door 22 is held by the case 11, which is taken along a line IIIA-IIIA in FIG. 2B. FIG. 3B is an enlarged side view of the defroster door 22. In FIG. 3B, a shape of a part of the case 11 is schematically shown by a dotted line.

As shown in FIG. 3A, second protruding parts (case side protruding parts) 11c are formed around the bearing holes 11b in the case 11. Each of the second protruding parts 11c protrudes to a side of the defroster door 22, and fits into the inner peripheral surface of each of the first protruding part 22d. The second protruding parts 11c have inner peripheral surfaces and the outer peripheral surfaces. The second protruding parts 11c are formed so that a distance between the outer peripheral surfaces and the axial center C of the rotation shaft 22a gradually decreases toward the direction shown by the arrow B, similarly to the inner peripheral surfaces of the first protruding parts 22d.

Further, the outer peripheral surfaces of the second protruding parts 11c are formed to have shapes fitting to shapes of the inner peripheral surfaces of the first protruding parts 22d when the door bodies 22b close the defroster air passage 24. In other words, when the door bodies 22b close the defroster air passage 24, the inner peripheral surfaces of the first protruding parts 22d are in contact with the outer peripheral surfaces of the second protruding parts 11c.

The inner peripheral surfaces of the first protruding parts 22d are tilted toward sides of the outer peripheral surfaces of the second protruding parts 11c. In other words, the inner peripheral surfaces of the first protruding parts 22d presses to the second protruding parts 11c toward sides of the axial ends of the rotation shaft 22a. In this way, the first protruding parts 22d are in contact with the second protruding parts 11c for sealing gaps between the first protruding parts 22d and the second protruding parts 11c.

That is, in the first embodiment, the inner peripheral surfaces of the first protruding parts 22d form first seal parts 22f, and the outer peripheral surfaces of the second protruding parts 11c form second seal parts 11d. The seal parts 22f and 11d constructs a seal structure for preventing an air leak from gaps between surroundings of the ends of the rotation shaft 22a and the case 11.

The first seal parts 22f are formed on surfaces which extend to a circumferential direction around the axial center C, and the second seal parts 11d are formed on surfaces which extend to the circumferential direction around the axial center C. Therefore, the seal structure is easily formed by contacting the both surfaces of the first seal parts 22f and the second seal parts 11d.

The first seal parts 22f are arranged in the upstream space 24a on the upstream air side of the defroster door 24 when the door bodies 22b close the defroster air passage 24.

The seal parts 22f and 11d are formed along the shapes of first and second protruding parts 22d and 11c. Therefore, a first distance between each of the first seal parts 22f and the axial center C, and a second distance between each of the second seal parts 11d and the axial center C gradually decrease toward the direction shown by the arrow B. Here, the direction shown by the arrow B is an opening direction of the door bodies 22b, for opening the defroster passage 24. Thus, the first seal parts 22f and the second seal parts 11d have scroll shapes centering on the axial center C.

In this embodiment, the scroll shape is a shape in which a distance (scroll diameter) from the axial center C to a predetermined point on the scroll shape of the seal parts 22f or 11d gradually changes around the axial center C. The scroll shape draws a spiral excursion on a cross-sectional surface perpendicular to the axial center C. The scroll shape may include a shape drawing a spiral excursion in a range within 360°.

The shaft holding part 22e is inserted into the bearing hole 11b formed in the inner peripheral surface of the second protruding part 11c. The shaft holding part 22e is formed into a cylindrical shape. Inside the shaft holding part 22e, a link-member connecting hole 22g for connecting a link member which links the rotation shaft 22a with the outlet-mode door operation system.

Next, an operation of the defroster door 22 will be described with reference with FIGS. 3A-5B. As shown in FIGS. 3A and 3B, when the door bodies 22b close the defroster air passage 24, the sealing members 22c of the door bodies 22b contact the ribs 11a of the case 11, so as to seal the gap between the door bodies 22b and the case 11. Further, the first seal parts 22f and the second seal parts 11d seal the gap between the end portions of the rotation shaft 22a and the case 11.

In the first embodiment, the first protruding parts 22d forming the first seal parts 22f, are integrally formed with the sealing member 22c of the defroster door 22. Thus, boundaries between outer peripheral portions of the door bodies 22b and the rotation shaft 22f are sealed appropriately. Therefore, an air leak from the upstream air side of the defroster door 22 to the downstream air side of the defroster door 22 is prevented.

Further, the first seal parts 22f are arranged in the upstream space 24a when the door bodies 22b close the defroster air passage 24. Therefore, when the door bodies 22b close the defroster air passage 24, the door seal parts 22f prevent an air leak from the upstream air side of the defroster door 22 to the downstream air side of the defroster door 22 without being formed in whole area around the rotation shaft 22a.

When the first seal parts 22f are positioned in the upstream space 24a, the bearing holes 11b in the case 11 and the shaft holding parts 22e are positioned on the downstream air side with respect to the first seal parts 22f. Therefore, an air leak from the gap between the bearing holes 11b and the shaft holding parts 22e to the outside of the case 11 is also prevented.

The first seal parts 22f are tilted toward the second seal parts 11d to contact the second seal parts 11d with lines. Therefore, a pressing force of contact interfaces of the first seal parts 22f and the second seal parts 11d is increased compared with that when the first seal parts 22f are in contact with the second seal parts 11d with faces.

Further, the first protruding parts 22d for forming the first seal parts 22f are made of the elastic material. Therefore, the pressing force of contact interfaces of the first seal parts 22f and the second seal parts 11d are increased compared with that when the first seal parts 22f and the second seal parts 11d are made of inelastic materials. As a result, the seal structure of the first embodiment has a high sealing property.

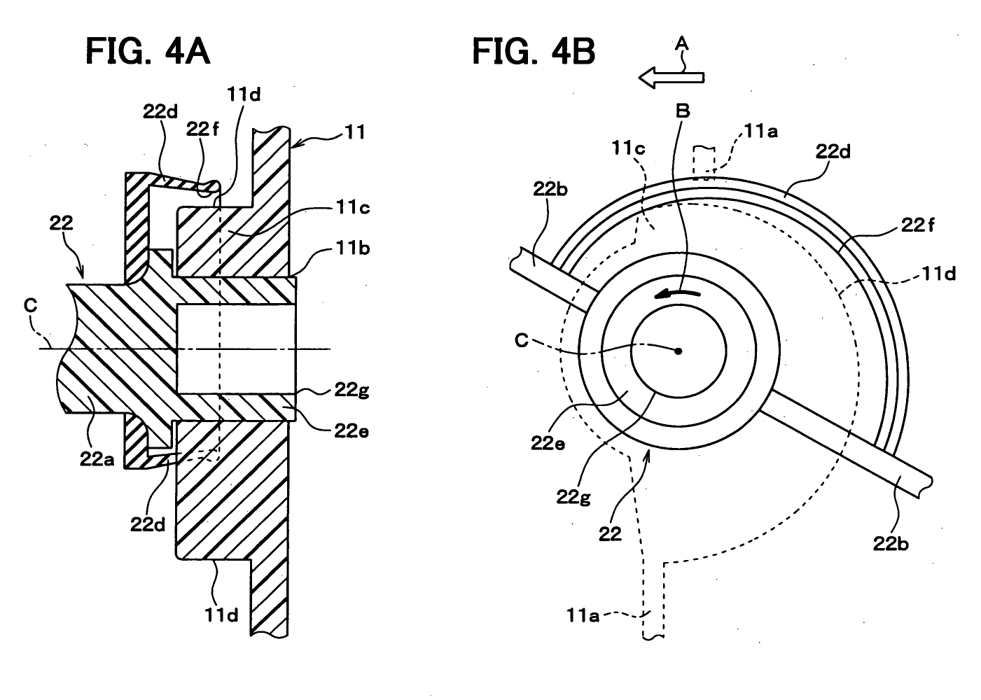

As shown in FIGS. 4A and 4B, when the door bodies 22b open the defroster air passage 24, the seal members 22c of the door bodies 22b and the ribs 11a, which construct the door seal structure, are separate from each other. Furthermore, the first seal parts 22f formed in the first protruding parts 22d integrally rotate with the rotation shaft 22a as shown in FIGS. 4A and 4B.

In the first embodiment, the first seal parts 22f and the second seal parts 11d have scroll shapes in which the first distance and the second distance change around the axial center C. The first seal part 22f is disposed on the outer peripheral side of the second seal part 11d, and the first distance and the second distance decrease toward the direction shown by the arrow B in FIG. 4B.

When the door bodies 24 rotate in the direction to open the defroster air passage 24 (i.e., the direction shown by the arrow B), the first distance becomes longer compared with the second distance in a certain radial direction. Thus, when the door bodies 24 rotate in the direction to open the defroster air passage 24, the first seal parts 22f rotate in a direction to separate from the second seal parts 11d as shown in FIG. 4B.

When the rotation shaft 22a rotates, an area of the contact interfaces between the first seal parts 22f and the second seal parts 11d is reduced. Therefore, a friction between the first seal parts 11f and the second seal parts 11d is reduced. As a result, the rotation shaft 22a is rotatable without increasing an operation force. Further, a noise due to the friction between the first seal parts 22f and the second seal parts 11d is prevented.

For obtaining the above-described effect, the door seal structure is only required to have a structure such that the first seal parts 22f are in contact with the second seal parts 11d only when the door bodies 22b close the defroster air passage 24, and the first seal parts 22f separate from the second seal parts 11d when the door bodies 22b start to move in the direction to open the defroster air passage 24.

In the first embodiment, the first protruding parts 22d are made of the elastic material for increasing the pressing force of the contact interfaces between the first seal parts 22f and the second seal parts 11d, and for improving the sealing property of the door seal structure.

Thus, when the door bodies 22b start to move in the direction to open the defroster air passage 24, the contact interfaces remain a little. However, at this time, the first seal parts 22f move in the direction to separate from the second seal parts 11d, thereby, the operation force to rotate the rotation shaft 22a is reduced.

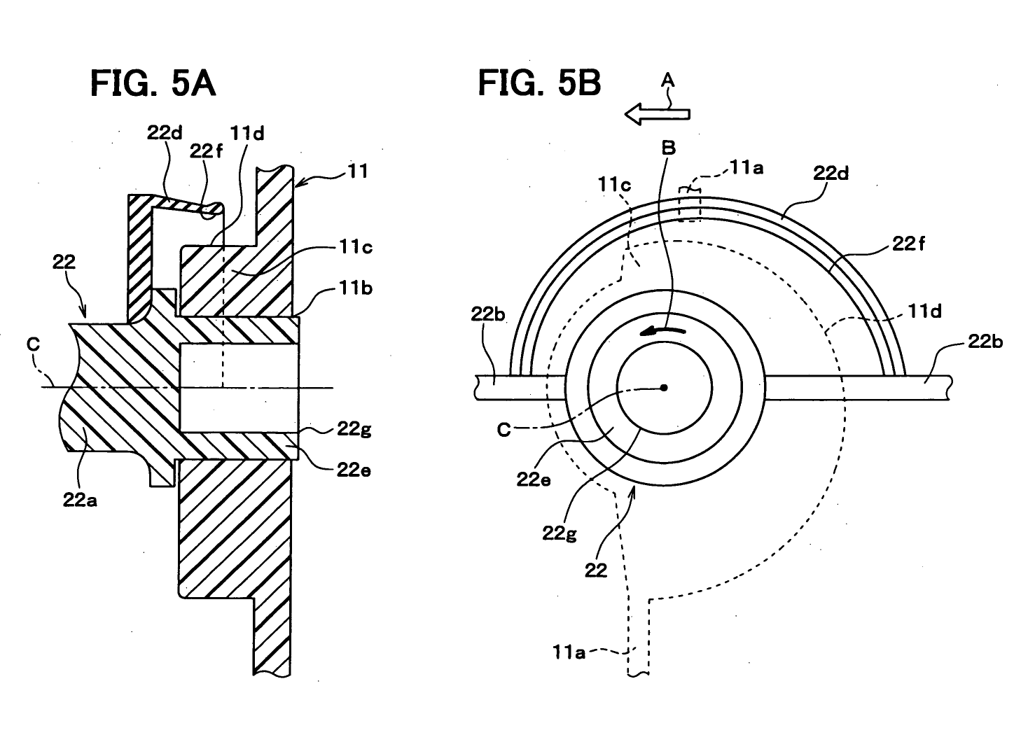

When the door bodies 22b fully open the defroster air passage 24, the seal members 22c of the door bodies 22b separate from the ribs 11a of the case 11, and the first seal parts 22f separate from the second seal parts 11d, as shown in FIGS. 5A and 5B. Therefore, air flows from the upstream air side to the downstream air side of the defroster door 22.

As described above, in the air passage switching device according to the first embodiment, when the door bodies 22b close the defroster air passage 24, the first seal parts 22f positioned at axial end portions of the defroster door 22 are in contact with the second seal parts 11d for preventing an air leak from the upstream air side to the downstream air side of the defroster door 22. Further, when the door bodies 22b rotate in the direction to open the defroster air passage 24, the first seal parts 22f rotate in the direction to separate from the second seal parts 11d. Therefore, the rotation shaft 22a is suitably rotatable without increasing the operation force.

### Second Embodiment

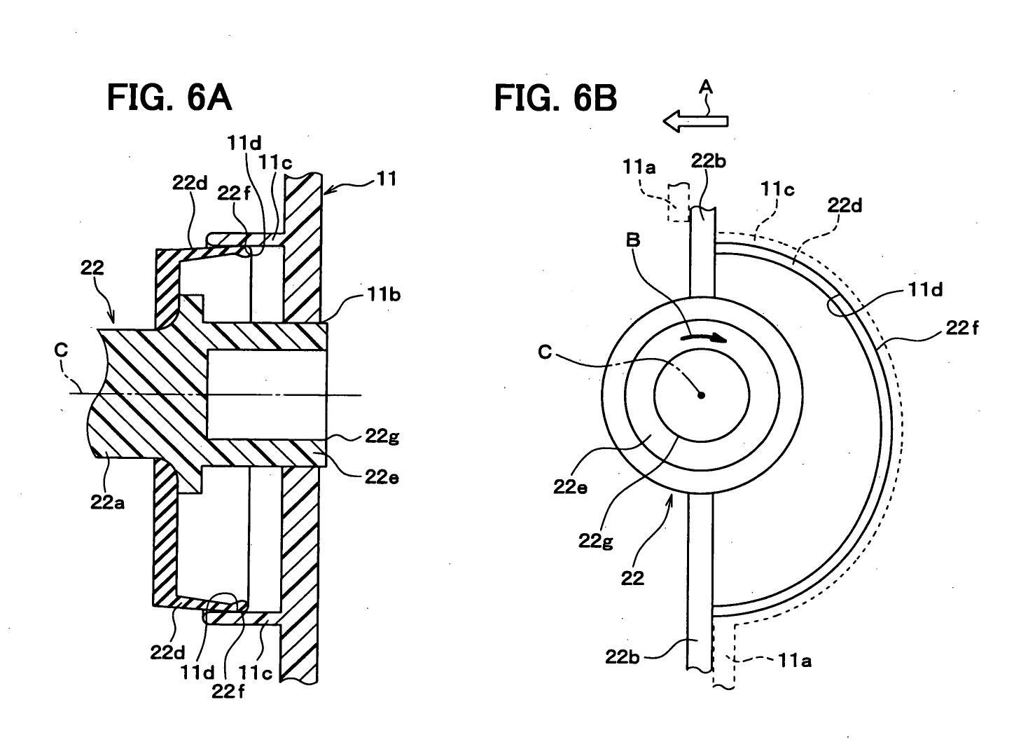

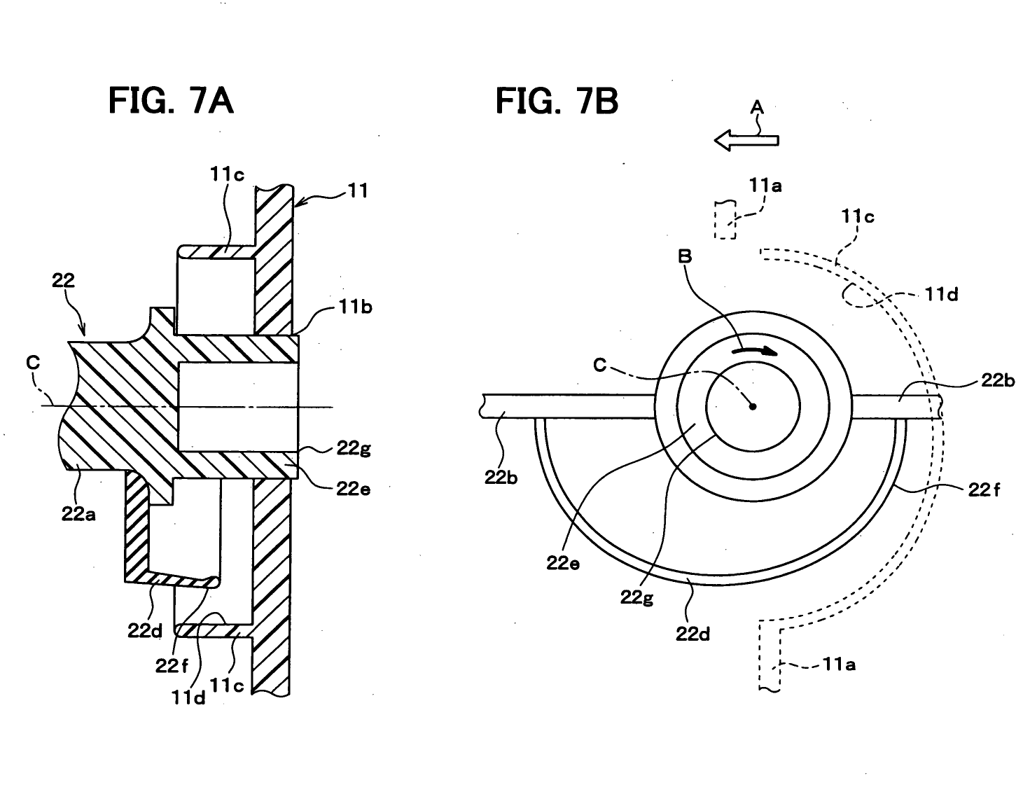

In the above-described first embodiment, the first seal parts 22f of the first protruding parts 22d press-contact the second seal parts 11d of the second protruding parts 11c from the radial outside of the second protruding part 11C. However, an air passage switching device according to a second embodiment of the invention has a seal structure in which the first protruding parts 22d are inserted in the second protruding parts 11c in a radial direction, as shown in FIG. 6A-7B.

The first protruding parts 22d are formed so that a distance between the outer peripheral surfaces of the first protruding parts 22d and the axial center C gradually increases toward the direction in which the door bodies 22b open the defroster air passage 24 (i.e., the direction shown by the arrow B).

The second protruding parts 11c are formed around the bearing holes 11b of the case 11, to protrude to the sides of the defroster door 22. The first protruding parts 22d are inserted into the second protruding part 11c in the radial direction. The second protruding part 11c are formed so that a distance between the inner peripheral surfaces of the second protruding parts 11c and the axial center C gradually increases toward the direction in which the door bodies 22b open the defroster air passage 24, similarly to the first seal parts 22f.

Further, the inner peripheral surfaces of the second protruding parts 11c are formed to have shapes fitting to shapes of the outer peripheral surfaces of the first protruding parts 22d when the door bodies 22b close the defroster air passage 24. As shown in FIG. 6B, when the door bodies 22b close the defroster air passage 24, the outer peripheral surfaces of the first protruding parts 22d are in contact with the inner peripheral surfaces of the second protruding parts 11c.

In this way, when the outer peripheral surfaces of the first protruding parts 22d are in contact with the inner peripheral surfaces of the second protruding parts 11c, the gaps between the first protruding parts 22d and the second protruding parts 11c are sealed. Thus, in the second embodiment, the outer peripheral surfaces of the first protruding parts 22d form the first seal parts 22f, and the inner peripheral surfaces of the second protruding parts 11c form the second seal parts 11d. The first seal parts 22f and the second seal parts 11d are formed to construct the seal structure.

The first seal parts 22f and the second seal parts 11d have scroll shapes in which the first distance between each of the first seal parts 22f and the axial center C and the second distance between each of the second seal parts 11d and the axial center C gradually increase toward the direction (i.e., the direction shown by the arrow B in FIG. 6B) in which the door bodies 22b open the defroster air passage 24.

In the second embodiment, the direction in which the door bodies 22b open the defroster air passage 24, i.e., the direction shown by the arrow B is a clockwise, contrary to that of the first embodiment. The other parts of the air passage switching device according to the second embodiment are similar with those of the first embodiment.

When the door bodies 22b close the defroster air passage 24, the door seal structure constructed with the sealing members 22c and the ribs 11a is formed to seal the gap between the door bodies 22b and the case 11. Further, the seal structure constructed with the first seal parts 22f and the second seal parts 11d is formed to seal the gap between the end portions of the rotation shaft 22a and the case 11. Therefore, the air passage switching device according to the second embodiment prevents an air leak from the upstream air side to the downstream air side of the defroster door 22.

As shown in FIGS. 7A and 7B, when the door bodies 22b fully open the defroster air passage 24, the seal members 22c of the door bodies 24 and the ribs 11a of the case 11 are separate from each other, and the first seal parts 22f and the second seal parts 11d are separate from each other. Therefore, the air flows from the upstream air side to the downstream air side of the defroster door 22.

When the door bodies 22b open the defroster air passage 24, the first seal parts 22f formed in the first protruding parts 22d integrally rotate with the rotation shaft 22a. The first seal parts 22f are arranged to an inner peripheral side with respect to the second seal parts 11d. Furthermore, the first distance and the second distance gradually increase toward the direction in which the door bodies 22b open the defroster air passage 24.

Therefore, when the door bodies 22b rotate in the direction to open the defroster air passage 24, the first distance becomes shorter compared with the second distance in a certain radial direction as shown in FIGS. 7A and 7B. Thus, when the door bodies 22b rotate in the direction to open the defroster air passage 24, the first seal parts 22f rotate in a direction to separate from the second seal parts 11d.

Therefore, in the air passage switching device according to the second embodiment, similar effects with those of the first embodiment can be obtained.

### Other Embodiments

Although the present invention has been fully described in connection with the preferred embodiments thereof with reference to the accompanying drawings, it is to be noted that various changes and modifications will become apparent to those skilled in the art.

For example, in the first and second embodiments, the shapes of the first seal parts 22f and the second seal parts 11d are scroll shapes in which the first distance between each of the first seal parts 22f and the axial center C and the second distance between each of the second seal parts 11d and the axial center C gradually change around the axis of the axial center C. However, excursions of the first seal parts 22 and the second seal parts 11d in a direction perpendicular to the axial center C may be a part of an involute curve and a part of a cycloid curve.

In the first and second embodiments, the air passage switching device according to the invention is typically used for the switching system for the defroster air passage 24, for example. However, an application of the invention is not limited to the switching system for the defroster air passage 24. For example, the invention may be applied to an air passage switching device for the foot air passage 30 switched by the foot door 29 which is the butterfly door similar with the defroster door 22.

When the face door 28 and the air-mixing door 16 are butterfly doors, the invention may be applied to an air passage switching devices for the air passage switched by the face door 28 or the air-mixing door 16. The invention may be applied not only to the vehicle air conditioner but also to any air passage switching device being within the scope of the invention.

In the first and second embodiments, the first seal parts 22f are arranged in the first area 24a which is located on an upstream air side (the direction shown by the arrow A) when the door bodies 22b close the defroster air passage 24. However, even when the first seal parts 22f are arranged in the second area 24b which is located on a downstream air side of the defroster door 22, the seal structure can prevent an air leak from upstream air side to the downstream air side of the defroster door 22, when the door bodies 22b close the defroster passage 24.

In the butterfly door of the first and second embodiments, the rotation shaft 22a is disposed between the two door bodies 22b which are arranged in approximately parallel. Therefore, both the first area 24a and the second area 24b are provided around the axial center C in the range of 180°. Thus, the first seal parts 22f are arranged around the axial center C in the range of 180°.

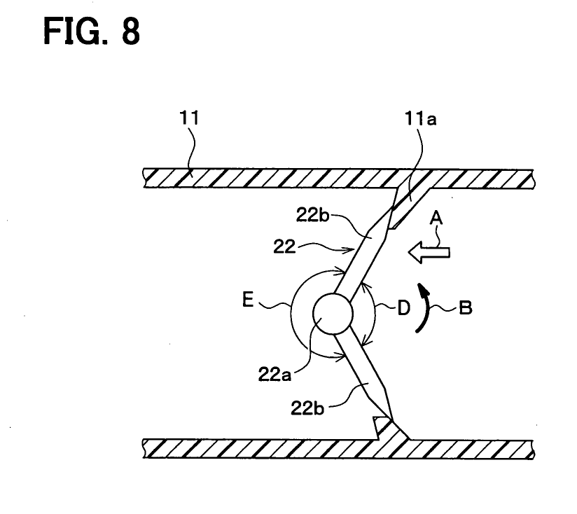

When the two door bodies 22b are arrange in nonparallel across the rotation shaft 22a, as shown in FIG. 8, a range (angle D) on an upstream air side and a range (angle E) on a downstream air side are different. When the first seal parts 22f are arranged in an area in a smaller range (the side of the angle D in FIG. 8), the seal structure becomes small.

In the first and second embodiments, the first protruding parts 22d are made of the elastic material and the second protruding parts 11c are made of the inelastic material. Alternatively, the first protruding parts 22d may be made of the inelastic material and the second protruding parts 11c may be made of the elastic material. In this case, the second protruding parts 11c is fixed with the case 11 by integrally formed with the case 11, and surfaces of the second protruding parts 11c which form the second seal parts 11d are tilted toward surfaces of the first protruding parts 22d which form the first seal parts 22f. Thus, the similar effect with those of the first and second embodiments can be obtained.

Further, each of the two door bodies 22b may have a different shape. When the door bodies 22b close the defroster air passage 24, the door bodies 22b are in contact with the ribs 11a on the surfaces on different sides. When the door bodies 22b have different lengths in the axial direction of the rotation shaft 22a, the sealing members 22c disposed in the outer end part of the both door bodies 22b and the first protruding parts 22d are integrally formed easily.

In the above-described embodiments, the present invention is applied to an air passage switching device with a butterfly door. However, the present invention can be applied to an air passage switching device with a door in which the rotation shaft 22a is not positioned at a center portion of the door body 22b. In this case, the rotation shaft 22a is disposed at a portion of the door body 22b to be rotated integrally with the door body 22b.

Such changes and modifications are to be understood as being within the scope of the present invention as defined by the appended claims.

What is claimed is:

1. An air passage switching device, comprising:
a case for defining an air passage through which air flows;
a butterfly door having a door body, and a rotation shaft, which is disposed at a center portion of the door body, for integrally rotating with the door body;
a bearing part provided in the case for rotatably holding the rotation shaft; and
a seal structure for preventing an air leak from a gap between the rotation shaft and the bearing part, wherein:
the seal structure has a first seal part disposed at an outer peripheral portion of the rotation shaft to be integrally rotated with the rotation shaft, and a second seal part disposed in the case;
the first seal part and the second seal part have scroll shapes centering on an axial center of the rotation shaft; and
the first seal part is in contact with the second seal part, when the door body closes the air passage.

2. The air passage switching device according to claim 1, wherein:
the first seal part is disposed to be positioned at an outer peripheral side of the second seal part; and
the scroll shape of each of the first seal part and the second seal part has a scroll diameter which decreases toward a direction in which the door body opens the air passage.

3. The air passage switching device according to claim 1, wherein:
the first seal part is disposed to be positioned at an inner peripheral side of the second seal part; and
the scroll shape of each of the first seal part and the second seal part has a scroll diameter which increases toward a direction in which the door body opens the air passage.

4. An air passage switching device, comprising:
a case for defining an air passage through which air flows;
a butterfly door having a door body, and a rotation shaft, which is disposed at a center portion of the door body, for integrally rotating with the door body;
a bearing part provided in the case for rotatably holding the rotation shaft; and
a seal structure for preventing an air leak from a gap between the rotation shaft and the bearing part, wherein:
the seal structure has a first seal part disposed at an outer peripheral portion of the rotation shaft to be integrally rotated with the rotation shaft, and a second seal part disposed in the case;
the first seal part is in contact with the second seal part throughout a circumference of the rotation shaft in a predetermined region in one of a region which is provided on an upstream air side of the door body, and a region which is provided on a downstream air side of the door body, when the door body closes the air passage.

5. An air passage switching device, comprising:
a case for defining an air passage through which air flows;
a butterfly door having a door body, and a rotation shaft, which is disposed at a center portion of the door body, for integrally rotating with the door body;
a bearing part provided in the case for rotatably holding the rotation shaft; and
a seal structure for preventing an air leak from a gap between the rotation shaft and the bearing part, wherein:
the seal structure has a first seal part which is disposed at an outer peripheral portion of the rotation shaft to be integrally rotated with the rotation shaft, and a second seal part disposed in the case;
the first seal part is in contact with the second seal part for preventing an air leak from an upstream air side to a downstream air side of the door body, when the door body closes the air passage; and
the first seal part moves in a direction in which the first seal part separates from the second seal part, when the door body rotates in a direction to open the air passage.

6. The air passage switching device according to claim 5, wherein:
the first seal part has a shape in which a distance between the first seal part and an axial center of the rotation shaft is changed around the axial center; and
the second seal part has a shape to fit with the shape of the first seal part when the door body closes the air passage.

7. The air passage switching device according to claim 6, wherein:
the first seal part is disposed to be positioned at an outer peripheral side of the second seal part; and
a distance between the first seal part and the axial center decreases toward a direction in which the door body opens the air passage.

8. The air passage switching device according to claim 6, wherein:
the first seal part is disposed to be positioned at an inner peripheral side of the second seal part; and
a distance between the first seal part and the axial center increases toward a direction in which the door body opens the air passage.

9. The air passage switching device according to claim 1, wherein:
the butterfly door has a first protruding part which is disposed on an outer peripheral side of a longitudinal end part of the rotation shaft to protrude to a side of the case;
the case has a second protruding part which protrudes to a side of the butterfly door to fit with the first protruding part;
the first seal part is formed on a first surface of the first protruding part, and the first surface extends in a circumferential direction around the axial center; and
the second seal part is formed on a second surface of the second protruding part, and the second surface extends in the circumferential direction around the axial center.

10. The air passage switching device according to claim 9, wherein:
one of the first surface of the first protruding part and the second surface of the second protruding part is tilted toward the other one of the first surface and the second surface.

11. The air passage switching device according to claim 9, wherein:
one of the first protruding part and the second protruding part is made of an elastic material which is elastically deformable.

12. The air passage switching device according to claim 1, further comprising:
a door seal structure including a seal member disposed at an outer peripheral end part of the door body and a rib provided in the case, wherein:
the seal member is in contact with the rib for sealing a gap between the door body and the case; and
the first seal part is integrally formed with the seal member.
